(19) United States
(12) Patent Application Publication
(10) Pub. No.: US 2016/0066106 A1
(43) Pub. Date: Mar. 3, 2016

(54) MOBILE AUDIO RECEIVER

(71) Applicant: Auditory Labs, LLC, Westlake, OH (US)

(72) Inventors: BRIAN T. GORDAN, Westlake, OH (US); NADIA M. GORDON, Westlake, OH (US)

(73) Assignee: AUDITORY LABS, LLC, Westlake, OH (US)

(21) Appl. No.: 14/837,764

(22) Filed: Aug. 27, 2015

Related U.S. Application Data
(60) Provisional application No. 62/042,331, filed on Aug. 27, 2014.

(51) Int. Cl. H04R 25/00

(52) U.S. Cl. CPC H04R 25/556; H04R 2420/09

(57) ABSTRACT

An assistive listening device that comprises a receiver for a digital signal that is tuned to receive a particular digital signal and a connector that includes a permanently mounted Apple Lightning or a mini/micro type-B or type-C USB connector or a standard type-A USB connector that serves as a conduit for a digital signal to a recoding or retransmittal device and as a conduit for transferring power to the mobile assistive listening device.

### RELATED APPLICATIONS

This application claims the benefit of provisional patent application Ser. No. 62/042,331 ('331) and its filing date Aug. 27, 2014. The present invention incorporates all of the subject matter disclosed in '331 as if it were fully rewritten herein.

### FIELD OF INVENTION

The present invention is in the field of assistive listening devices for the deaf and hard of hearing or other persons with disabilities.

### SUMMARY OF INVENTION

An assistive listening device that comprises a receiver for a digital signal and a connector that serves as a conduit for the signal to a recoding or retransmittal device, preferably a handheld mobile device. The assistive listening device is powered externally through that permanently mounted connective interface. Methods employing the assistive listening device to convert human voice audio to text at locations remote from the speaker are also disclosed and claimed.

### DETAILS OF INVENTION

The invention is a peripheral component device that receives human voice audio transmitted by a digital transmitter with microphone, often referred to as a personal FM or DM system, and transmits that human voice audio to a mobile device, and methods employing the same.

### BRIEF DESCRIPTION OF THE DRAWINGS

FIG. 1 is a flow diagram depicting the flow of information or signals through the entire system.

FIG. 2 depicts one embodiment of the assistive listening device.

FIG. 3 depicts another embodiment of the assistive listening device.

FIG. 4 depicts another embodiment of the assistive listening device.

FIG. 5 depicts the assistive listening device connected to a mobile device.

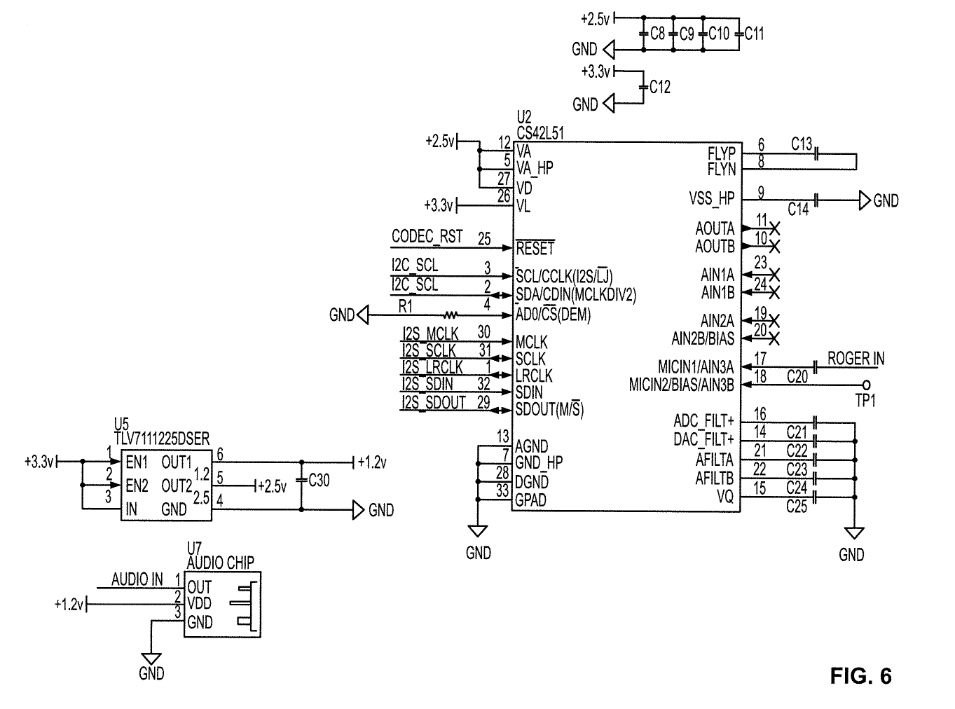

FIG. 6 is the electrical schematic of the assistive listening device.

### DESCRIPTION OF PREFERRED EMBODIMENTS

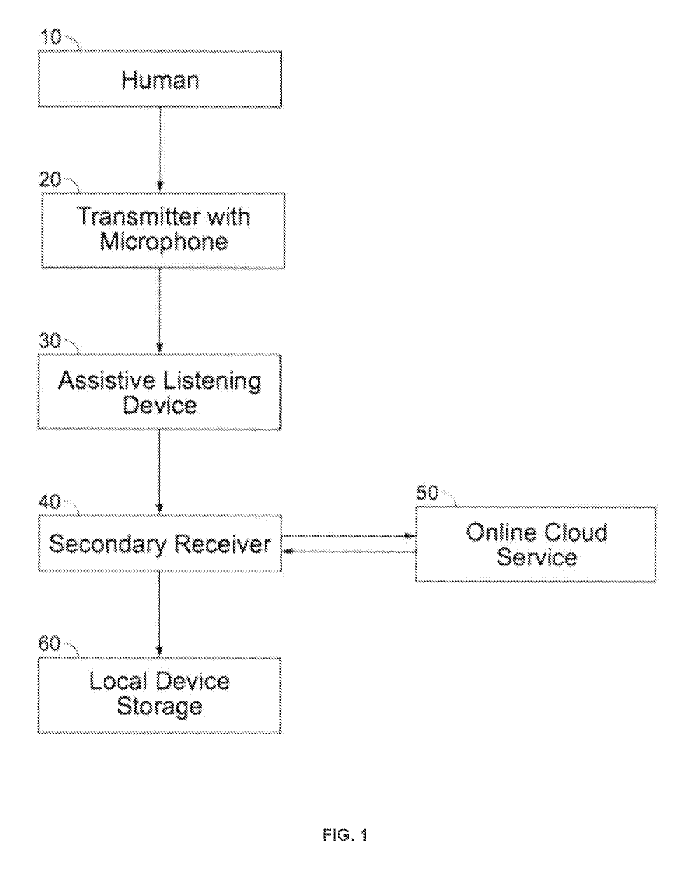

Referring initially to the drawings, FIG. 1 is a flow diagram that includes the assistive listening device of the instant invention. The assistive listening device of the instant invention is used normally with spoken voice audio emanating from human 10, which may be live or recorded. Additional sounds may also be included.

Audio emanating from human 10 is transmitted via initial transmitter with microphone 20 which is then received into the assistive listening device 30 that comprises a digital receiver. The carrier frequency transmitted by initial transmitter 20 to be received by the digital receiver includes, but is not limited to 2.4 GHz. The 2.4 GHz communication platform may be of a proprietary nature or license free. A proprietary communication platform may include but is not limited to the Phonak Roger 2.4 GHz communication platform. The initial transmitter with microphone 20 may be any one of a number of commercially available digital transmitters that include a microphone 20, such as are used in the classroom for the deaf and hard of hearing. Commercially available devices include but are not limited to Phonak Roger Inspiro, Phonak Roger Clip-on Mic, Phonak Roger Pen, Oticon Amigo family, and others.

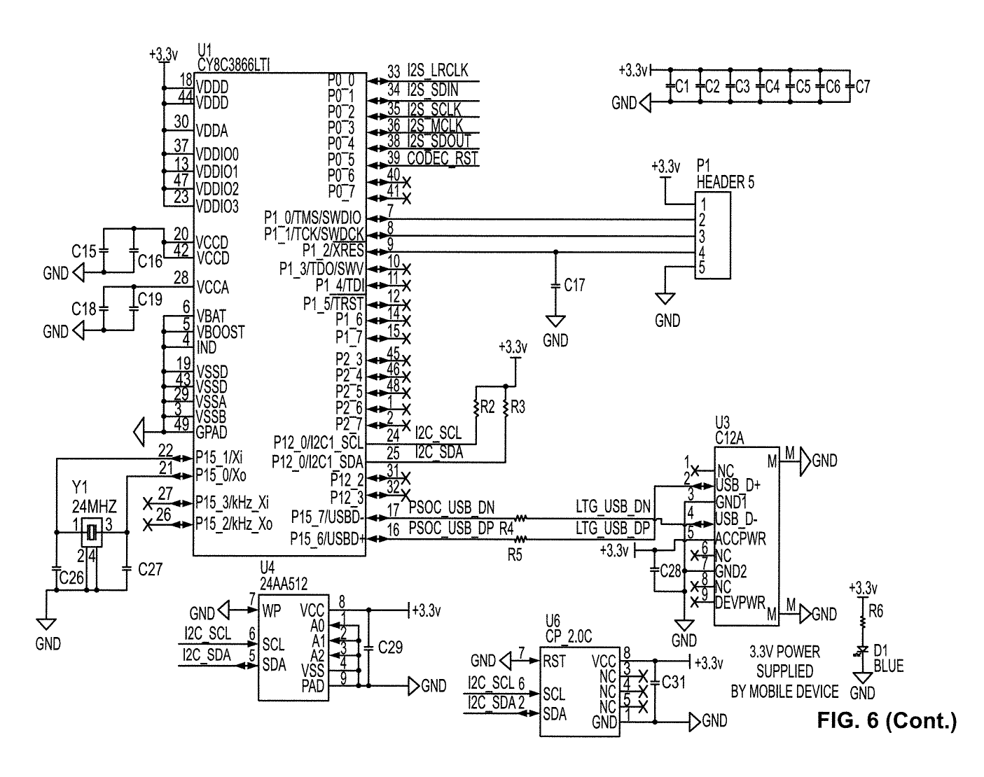

The assistive listening device 30 comprises electronic hardware including a digital receiver for the purpose of receiving the digital signal emanating from the transmitter 20, then transmitting the signal to a secondary receiver 40 for further handling or manipulation. As one skilled in the art would appreciate with reference to FIG. 6, assistive listening device 30 comprises a radio frequency receiver set or adjustably set to the frequency of transmitter with microphone 20, and a retransmitter to transmit signal to secondary receiver 40.

There is software resident in the secondary receiver component 40 that controls the recordation of the audio received therein and that stores such audio (as digital signal) on either a local storage device 60 of the secondary receiver component 40 or at an online cloud service 50 for later playback and perhaps further manipulation. The software in the secondary receiver component 40 also has the ability to send the recorded audio to an offsite location via the Internet to be transcribed using any one of a number of commercially available machine or human generated transcription services. Optionally, the software in the secondary receiver component 40 also has the ability to create, control and receive transcriptions from any one of a number of commercially available machine or human generated transcription services. Commercially available machine or human generated transcription services includes but are not limited to Nuance, VoiceBase, Apple Suri, Google Voice Recognition and others.

The interface between the assistive listening device 30 of the instant invention and the secondary receiver component 40 is accomplished mechanically through a permanently mounted connector such as an Apple Lightning connector 33 or a mini/micro type-B or type-C USB connector 35 or a standard type-A USB connector 37. The secondary receiver component 40 is any one of a number of well-known devices that may be used to accept an Apple Lightning connector 33 or a mini/micro type-B or type-C USB connector 35 or a standard type-A USB connector 37 to receive a signal broadcast from the assistive listening device 30. The secondary receiver component 40 devices include, but are not limited to, laptop computers, mobile smartphones and tablet computers of any screen size. The secondary receiver component 40 may employ an application or software that enables power transfer to the assistive listening device 30.

The assistive listening device 30 is composed of a printed circuit board assembly (PCBA) that itself is comprised of well-known electronic components. Power is provided to the components externally through an Apple Lightning connector 33 or a mini/micro type-B or type-C USB connector 35 or a standard type-A USB connector 37 interface. The PCBA includes circuitry for transferring power from the secondary receiver 40 to assistive listening device 30 via the permanently mounted Apple Lightning connector 33 or a mini/micro type-B or type-C USB connector 35 or a standard type-A USB connector 37 interface. The assistive listening device 30 may also include automatic channel tuning or may include frequency-hopping technology.

Alternately, the assistive listening device 30 may have power provided to the components through one or more disposable or rechargeable batteries.

The software in the secondary receiver component 40 may be a mobile application also referred to as an app, in which the graphical user interface would include but not be limited to “soft” buttons for powering and control of the assistive listening device 30. Features of the software portion of the invention are not limited to those mentioned above.

The mobile operating systems for the mobile application can include but are not limited to Apple iOS, Apple OS X, Google Android, Google Chrome and Microsoft Windows.

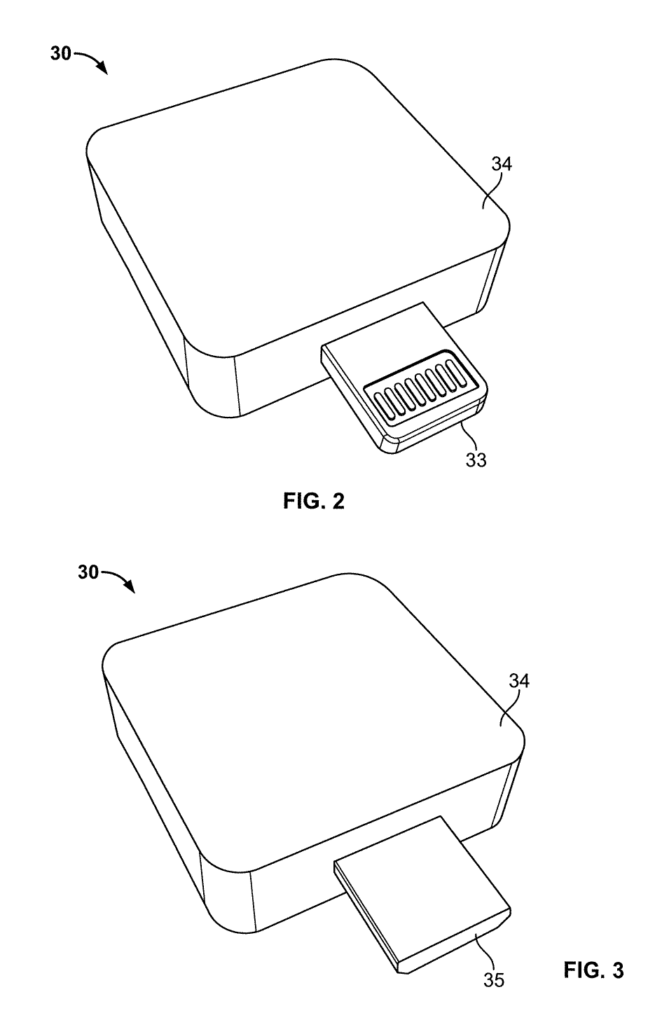

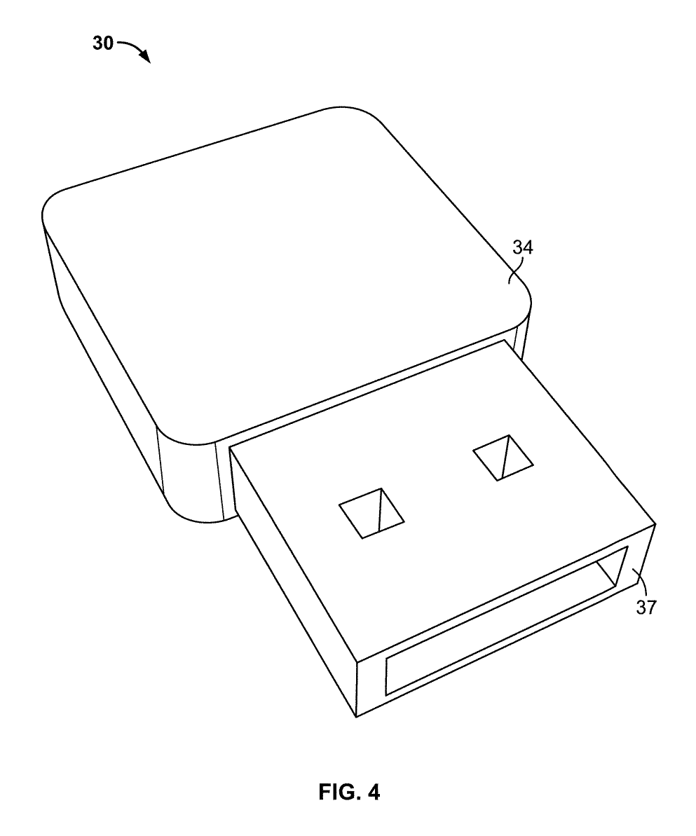

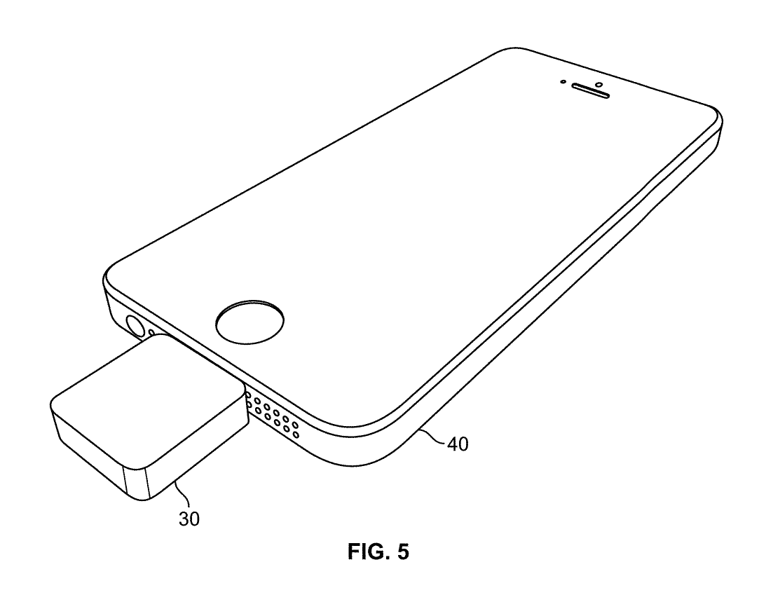

FIGS. 2, 3 and 4 depict three possible designs of the assistive listening device 30. Showing the external case 34 along with an Apple Lightning connector 33 or a mini/micro type-B or type-C USB connector 35 or a standard type-A USB connector 37.

A first use case is a student of any age that may be deaf or hard of hearing using the invention in a classroom setting. The teacher or classroom lecturer would wear a personal FM or digital transmitter with or without a boom microphone and the student would use the invention to transmit audio directly to a mobile device.

A second use case is an individual of any age that may be deaf or hard of hearing or having some other special need using the invention in settings such as theaters, places of worship, museums, public meeting places, corporate conference rooms, convention centers, and other large areas for gathering to transmit audio directly to a mobile device.

The foregoing descriptions of specific embodiments of the present invention are presented for purposes of illustration and description. They are not intended to be exhaustive nor are they intended to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the drawings and specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722 (2002), or other similar caselaw or subsequent precedent should not be made if any future claims are added or amended subsequent to this patent application.

What is claimed is:

1. An assistive listening device system comprising, in combination,
an assistive listening device;
a storage means for storing a digital signal, remote from said assistive listening device; and
a connector means for connecting the transmitter means of said assistive listening device and the storage means.

2. The assistive listening device system of claim 1 wherein the assistive listening device comprises
a means for receiving a broadcast digital signal;
a power means for powering said assistive listening device; and
a transmitter means.

3. The assistive listening device of claim 2 wherein the signal receiving means includes means for receiving a broadcast digital signal.

4. The assistive listening device of claim 2 wherein the power means is an internal battery.

5. The assistive listening device of claim 2 wherein the power means comprises a circuit internal to the assistive listening device that transfers power from a device remote from said assistive listening device.

6. An assistive listening device system comprising, in combination,
an assistive listening device;
a storage means for storing said digital signal, remote from said assistive listening device; and
a connector means for connecting the transmitter means of said assistive listening device and the storage means
wherein the assistive listening device comprises
a signal receiving means;
a power means for powering said assistive listening device; and
a transmitter means;
wherein the power means further comprises a circuit internal to the assistive listening device that transfers power from a device remote from said assistive listening device.
